(19) United States
(12) Patent Application Publication
(10) Pub. No.: US 2026/0072932 A1
(43) Pub. Date: Mar. 12, 2026

(54) System, Method, and Computer Program Product for Extracting Parameters from Documents

(71) Applicant: Clearbrief, Inc., Seattle, WA (US)

(72) Inventors: Jacqueline Grace Schafer, Seattle, WA (US); Jose Demetrio Saura, Covington, WA (US)

(21) Appl. No.: 19/326,843

(22) Filed: Sep. 12, 2025

Related U.S. Application Data
(60) Provisional application No. 63/693,738, filed on Sep. 12, 2024.

(51) Int. Cl. G06F 16/25; G06F 16/906; G06F 16/93

(52) U.S. Cl. CPC G06F 16/254; G06F 16/906; G06F 16/93

(57) ABSTRACT

Provided are systems, methods, and computer program products for extracting parameters from documents. The system includes at least one processor programmed or configured to receive at least one document from a user device, generate at least one signature based on the at least one document, compare the at least one signature to the plurality of forms to identify at least one matching form, input the at least one document and the at least one instruction corresponding to the at least one matching form into a machine-learning model configured to extract values from the at least one document, and generate at least one user interface based on the values extracted from the at least one document.

### CROSS-REFERENCE TO RELATED APPLICATION

This application claims the benefit of U.S. Provisional Application No. 63/693,738, filed September 12, 2024, the entirety of which is hereby incorporated by reference.

### BACKGROUND

### 1. Field

This disclosure relates generally to document processing and, in some non-limiting embodiments or aspects, to systems, methods, and computer program products for extracting parameters from documents.

### 2. Technical Considerations

Extracting data from a document can be a resource-intensive process that involves carefully analyzing the document, which may not be in a recognized format, and identifying the desired information. Doing such extraction automatically can lead to inaccurate and/or inconsistent results.

### SUMMARY

According to non-limiting embodiments or aspects, provided is a system comprising: a data storage device comprising a plurality of forms, each form of the plurality of forms corresponding to at least one instruction; and at least one processor configured to: receive at least one document from a user device; generate at least one signature based on the at least one document; compare the at least one signature to the plurality of forms to identify at least one matching form; input the at least one document and the at least one instruction corresponding to the at least one matching form into a machine-learning model configured to extract values from the at least one document; and generate at least one user interface based on the values extracted from the at least one document.

In non-limiting embodiments or aspects, the at least one processor is further configured to: generate a signature for each form of the plurality of forms based on at least one parameter field in each form, wherein comparing the at least one signature to the plurality of forms comprises comparing the at least one signature to each signature for each form to identify the at least one matching form. In non-limiting embodiments or aspects, wherein inputting the at least one instruction into the machine-learning model comprises: generating a prompt based on the at least one instruction; and inputting the prompt and the at least one document into the machine-learning model. In non-limiting embodiments or aspects, the data storage device comprises a first form repository and a second form repository, the first form repository comprises the plurality of forms, the plurality of forms are predetermined, and the second form repository comprises a second plurality of forms uploaded by a user. In non-limiting embodiments or aspects, wherein comparing the at least one signature to the plurality of forms to identify the at least one matching form comprises separately comparing a signature of each individual page of the at least one document to the plurality of forms. In non-limiting embodiments or aspects, wherein generating the at least one signature based on the at least one document comprises determining a classification for each parameter field in the at least one document.

In non-limiting embodiments or aspects, wherein generating at least one user interface based on the values extracted from the at least one document comprises at least one of the following: generating a timeline of events based on the values, generating a table comprising a plurality of columns, wherein each column of the plurality of columns corresponds to a classification of a value of the values extracted from the at least one document, or any combination thereof. In non-limiting embodiments or aspects, the at least one processor is further configured to: before inputting the at least one instruction into the machine-learning model, display the at least one instruction on the user device; and modify the at least one instruction based on user input received through the user device. In non-limiting embodiments or aspects, the at least one processor is further configured to: receive at least one second document from the user device; generate at least one second signature based on the at least one second document; determine that the at least one signature does not match any form of the plurality of forms; in response to determining that the at least one signature does not match any form of the plurality of forms, prompt a user of the user device to identify parameter fields of the at least one document; and add the at least one second document to the plurality of forms.

According to non-limiting embodiments or aspects, provided is a computer-implemented method comprising: receiving at least one document from a user device; generating, with at least one processor, at least one signature based on the at least one document; comparing, with at least one processor, the at least one signature to a plurality of forms to identify at least one matching form; inputting, with at least one processor, the at least one document and at least one instruction corresponding to the at least one matching form into a machine-learning model configured to extract values from the at least one document; and generating, with at least one processor, at least one user interface based on the values extracted from the at least one document.

In non-limiting embodiments or aspects, the method includes: generating a signature for each form of the plurality of forms based on at least one parameter field in each form, wherein comparing the at least one signature to the plurality of forms comprises comparing the at least one signature to each signature for each form to identify the at least one matching form. In non-limiting embodiments or aspects, wherein inputting the at least one instruction into the machine-learning model comprises: generating a prompt based on the at least one instruction; and inputting the prompt and the at least one document into the machine-learning model. In non-limiting embodiments or aspects, the data storage device comprises a first form repository and a second form repository, the first form repository comprises the plurality of forms, the plurality of forms are predetermined, and the second form repository comprises a second plurality of forms uploaded by a user. In non-limiting embodiments or aspects, wherein comparing the at least one signature to the plurality of forms to identify the at least one matching form comprises separately comparing a signature of each individual page of the at least one document to the plurality of forms. In non-limiting embodiments or aspects, wherein generating the at least one signature based on the at least one document comprises determining a classification for each parameter field in the at least one document.

In non-limiting embodiments or aspects, wherein generating at least one user interface based on the values extracted from the at least one document comprises at least one of the following: generating a timeline of events based on the values, generating a table comprising a plurality of columns, wherein each column of the plurality of columns corresponds to a classification of a value of the values extracted from the at least one document, or any combination thereof. In non-limiting embodiments or aspects, the method includes: before inputting the at least one instruction into the machine-learning model, displaying the at least one instruction on the user device; and modifying the at least one instruction based on user input received through the user device. In non-limiting embodiments or aspects, the method includes: receiving at least one second document from the user device; generating at least one second signature based on the at least one second document; determining that the at least one signature does not match any form of the plurality of forms; in response to determining that the at least one signature does not match any form of the plurality of forms, prompting a user of the user device to identify parameter fields of the at least one document; and adding the at least one second document to the plurality of forms.

According to non-limiting embodiments or aspects, provided is a computer program product comprising at least one non-transitory computer-readable medium including program instructions that, when executed by at least one processor, cause the at least one processor to: receive at least one document from a user device; generate at least one signature based on the at least one document; compare the at least one signature to the plurality of forms to identify at least one matching form; input the at least one document and at least one instruction corresponding to the at least one matching form into a machine-learning model configured to extract values from the at least one document; and generate at least one user interface based on the values extracted from the at least one document.

Further non-limiting embodiments and aspects are provided in the following clauses:

Clause 1: A system comprising: a data storage device comprising a plurality of forms, each form of the plurality of forms corresponding to at least one instruction; and at least one processor configured to: receive at least one document from a user device; generate at least one signature based on the at least one document; compare the at least one signature to the plurality of forms to identify at least one matching form; input the at least one document and the at least one instruction corresponding to the at least one matching form into a machine-learning model configured to extract values from the at least one document; and generate at least one user interface based on the values extracted from the at least one document.

Clause 2: The system of clause 1, wherein the at least one processor is further configured to: generate a signature for each form of the plurality of forms based on at least one parameter field in each form, wherein comparing the at least one signature to the plurality of forms comprises comparing the at least one signature to each signature for each form to identify the at least one matching form.

Clause 3: The system of clause 1 or 2, wherein inputting the at least one instruction into the machine-learning model comprises: generating a prompt based on the at least one instruction; and inputting the prompt and the at least one document into the machine-learning model.

Clause 4: The system of any of clauses1-3, wherein the data storage device comprises a first form repository and a second form repository, wherein the first form repository comprises the plurality of forms, wherein the plurality of forms are predetermined, and wherein the second form repository comprises a second plurality of forms uploaded by a user.

Clause 5: The system of any of clauses 1-4, wherein comparing the at least one signature to the plurality of forms to identify the at least one matching form comprises separately comparing a signature of each individual page of the at least one document to the plurality of forms.

Clause 6: The system of any of clauses 1-5, wherein generating the at least one signature based on the at least one document comprises determining a classification for each parameter field in the at least one document.

Clause 7: The system of any of clauses 1-6, wherein generating at least one user interface based on the values extracted from the at least one document comprises at least one of the following: generating a timeline of events based on the values, generating a table comprising a plurality of columns, wherein each column of the plurality of columns corresponds to a classification of a value of the values extracted from the at least one document, or any combination thereof.

Clause 8: The system of any of clauses 1-7, wherein the at least one processor is further configured to: before inputting the at least one instruction into the machine-learning model, display the at least one instruction on the user device; and modify the at least one instruction based on user input received through the user device.

Clause 9: The system of any of clauses 1-8, wherein the at least one processor is further configured to: receive at least one second document from the user device; generate at least one second signature based on the at least one second document; determine that the at least one signature does not match any form of the plurality of forms; in response to determining that the at least one signature does not match any form of the plurality of forms, prompt a user of the user device to identify parameter fields of the at least one document; and add the at least one second document to the plurality of forms.

Clause 10: A computer-implemented method comprising: receiving at least one document from a user device; generating, with at least one processor, at least one signature based on the at least one document; comparing, with at least one processor, the at least one signature to a plurality of forms to identify at least one matching form; inputting, with at least one processor, the at least one document and at least one instruction corresponding to the at least one matching form into a machine-learning model configured to extract values from the at least one document; and generating, with at least one processor, at least one user interface based on the values extracted from the at least one document.

Clause 11: The method of clause 10, further comprising: generating a signature for each form of the plurality of forms based on at least one parameter field in each form, wherein comparing the at least one signature to the plurality of forms comprises comparing the at least one signature to each signature for each form to identify the at least one matching form.

Clause 12: The method of clause 10 or 11, wherein inputting the at least one instruction into the machine-learning model comprises: generating a prompt based on the at least one instruction; and inputting the prompt and the at least one document into the machine-learning model.

Clause 13: The method of any of clauses10-12, wherein the data storage device comprises a first form repository and a second form repository, wherein the first form repository comprises the plurality of forms, wherein the plurality of forms are predetermined, and wherein the second form repository comprises a second plurality of forms uploaded by a user.

Clause 14: The method of any of clauses 10-13, wherein comparing the at least one signature to the plurality of forms to identify the at least one matching form comprises separately comparing a signature of each individual page of the at least one document to the plurality of forms.

Clause 15: The method of any of clauses 10-14, wherein generating the at least one signature based on the at least one document comprises determining a classification for each parameter field in the at least one document.

Clause 16: The method of any of clauses 10-15, wherein generating at least one user interface based on the values extracted from the at least one document comprises at least one of the following: generating a timeline of events based on the values, generating a table comprising a plurality of columns, wherein each column of the plurality of columns corresponds to a classification of a value of the values extracted from the at least one document, or any combination thereof.

Clause 17: The method of any of clauses 10-16 further comprising: before inputting the at least one instruction into the machine-learning model, displaying the at least one instruction on the user device; and modifying the at least one instruction based on user input received through the user device.

Clause 18: The method of any of clauses 10-17, further comprising: receiving at least one second document from the user device; generating at least one second signature based on the at least one second document; determining that the at least one signature does not match any form of the plurality of forms; in response to determining that the at least one signature does not match any form of the plurality of forms, prompting a user of the user device to identify parameter fields of the at least one document; and adding the at least one second document to the plurality of forms.

Clause 19: A computer program product comprising at least one non-transitory computer-readable medium including program instructions that, when executed by at least one processor, cause the at least one processor to: receive at least one document from a user device; generate at least one signature based on the at least one document; compare the at least one signature to the plurality of forms to identify at least one matching form; input the at least one document and at least one instruction corresponding to the at least one matching form into a machine-learning model configured to extract values from the at least one document; and generate at least one user interface based on the values extracted from the at least one document.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 illustrates a schematic diagram of a system for extracting parameters from documents according to non-limiting embodiments or aspects;

FIG. 2 illustrates a flow diagram for a method for extracting parameters from documents according to non-limiting embodiments or aspects; and

FIG. 3 illustrates example components of a device used in connection with non-limiting embodiments or aspects of systems, methods, and computer program products for extracting parameters from documents.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server, or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Provided herein are systems, methods, and computer program products for extracting parameters from documents that improve upon existing word processing systems and/or document searching systems. For example, systems and methods described herein may provide for an efficient use of machine-learning models and computational resources by comparing an input document for extraction to signatures of forms in a repository and identifying a matching form and set of instructions to prompt and/or instruct the machine-learning model. This reduces the amount of information that needs to be input in the model and thereby improves speed and efficiency. Through a unique architecture that includes a repository of forms and access to machine-learning models, document parameter extraction can be performed in an efficient and accurate manner.

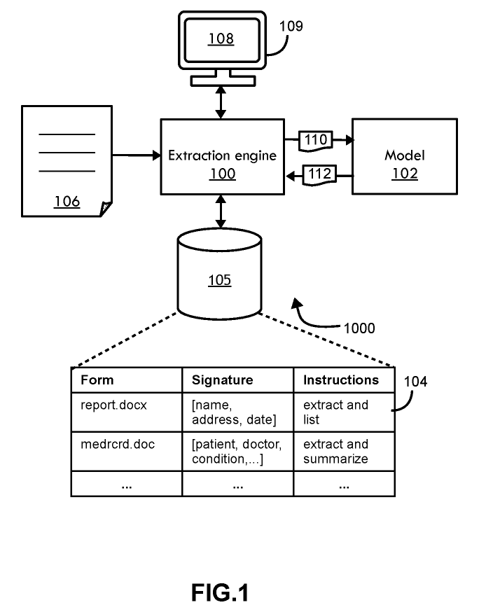

Referring now to FIG. 1, a system 1000 for extracting parameters from documents is shown according to non-limiting embodiments. The system 1000 includes an extraction engine 100, which may include one or more computing devices and/or software applications executed by one or more computing devices. In some non-limiting embodiments, the extraction engine 100 may be part of and/or be executed by a client computing device 109. Additionally or alternatively, the extraction engine 100 may be executed by one or more servers in communication with the client computing device 109. For example, the extraction engine 100 may be one or more client-side applications, one or more server-side applications, or a combination of client-side and server-side applications. It will be appreciated that different arrangements of computing devices may be used in some non-limiting embodiments.

With continued reference to FIG. 1, in some non-limiting embodiments the client computing device 109 may execute a word processing application or be in communication with a word processing application service. The word processing application may be a stand-alone application, may be provided within a web browser, and/or the like. The word processing application may display a graphical user interface (GUI) 108 on the client computing device 109. The GUI 108 may display a textual document. A user of the client computing device 109 may draft, edit, save, view, and interact with the textual document. The client computing device 109 may locally store the textual document and/or the textual document may be displayed from remote storage. The textual document may also be displayed on a document reading application such that it cannot be edited but a user can select text.

In some non-limiting embodiments, the extraction engine 100 may be in communication with a form database 104 stored on one or more data storage devices 105. The form database 104 may be local or remote to the client computing device 109 and/or extraction engine 100. The forms stored in the form database 104 may be stored in association with a signature. As used herein, the term “form” may refer to any document that includes information corresponding to one or more parameter fields.

For example, a form may include a legal complaint, a medical record, an intake questionnaire, a transcript, a police report, a repair history, an application, an email, a spreadsheet, a structured data file (e.g., a comma separated value (csv) file or the like), and/or the like. Parameters may include names, addresses, dates, categories, selections, and/or the like. Forms may be based on a template in some examples such that similar forms may include some or all of the same parameter fields. A medical record form may include, for example, a patient name, a physician name, a medical facility, a date of treatment, a patient complaint, and/or the like. A police report form may include an officer name, a defendant name, a location, an identification of a crime or statute, and/or the like. A template may include a predefined set of parameters and/or parameter fields to be expected for a form in a category. It will be appreciated that various types of forms may be used in connection with non-limiting embodiments.

Although the form database 104 is shown in FIG. 1 stored on single data storage device 105, it will be appreciated that any number of data storage devices 105 may be used in some non-limiting embodiments, arranged local and/or remote to the computing device 109. In some non-limiting embodiments, multiple data structures may be used to represent the form database 104, such as tables or arrays with pointers, graphs, and/or the like.

In some non-limiting embodiments, a parameter may include name of a party, address, complaint, court, date, narrative, and/or the like. As used herein, the term “parameter” refers to a value of a data element, such as a number, string, set of characters, selection, and/or the like. A “parameter field” refers to a type, classification, and/or category of information (e.g., parameter) that is expected in a portion of a form. A parameter field may or may not be explicitly delineated in the form. For example, a parameter field may be “first name” and the parameter value may be “John.” A value of the parameter field is the information itself (e.g., the name “John”) that forms the content of the field. In some examples, a parameter field value may be blank and in other examples a parameter field may include multiple responses and/or types of information as a value.

In some non-limiting embodiments, the signature for each form may be based on one or more parameter fields in the form. The signature may include, for example, a list or other data structure of parameter fields (e.g., a type, classification, category, etc.). In non-limiting embodiments, the signature may be an ordered list of parameter fields such as, for example, “[name, date, application number, title]”, “[first party, second party, docket number, court]”, and/or the like. In some non-limiting embodiments, the signature may be a processed output of a list of parameter fields, such as a hash of the parameter fields, a concatenated string of the parameter fields, and/or the like. It will be appreciated that a form signature may be any unique identifier based on the parameter fields of the form. Each form in the form database 104 may be associated with a signature and with one or more instructions. In some non-limiting embodiments, the signature may include or be associated with a unique title and/or identifier, such as a type, classification, or category of form (e.g., medical record, copyright application, police report, and/or the like) that is determined from the one or more parameter fields in the form. In some non-limiting embodiments, the signature for each form may be automatically generated in response to the form being uploaded and/or received in the form database 104. In other non-limiting embodiments, the signature for each form may be generated upon request and/or at intervals.

In some non-limiting embodiments, the instructions may include prompts and/or model input parameters for extracting and/or processing data from a document that matches a particular form. The instructions may include queries, formatting parameters (e.g., desired structure of data), output parameters (e.g., summarization and/or level of summarization, such as short summary, full text without summary, summary greater or less than a user-specified or predetermined number of words, narrative, and/or the like), parameter fields to extract values from, processing tasks to perform, and/or other guidelines or parameters that can be used to prompt or query a model. In some non-limiting embodiments, a model (e.g., such as model 102 or another model) may be used to generate the signatures. In non-limiting embodiments, as an example, a set of instructions for a document may prompt a model to extract a patient name, doctor name, and name of a procedure and list the values in an instance where the document is a medical record. An instruction may also ask for a condition or injury to be classified according to a scale (e.g., minor, major, severe, etc.). As another example, a legal complaint may be associated with a set of instructions to prompt a model to extract the nature of the complaint, the court it was filed in, and the date it was filed. In some non-limiting embodiments, a user may be able to edit the instructions in the form database 104 and/or the like. For example, an end-user, administrative user, and/or other type of user may input and/or edit instructions through a GUI 108. The instructions may be free form (e.g., in the form of plaintext prompts or the like) and/or may be a selection of options through a GUI 108.

With continued reference to FIG. 1, in some non-limiting embodiments a document 106 may be input into the extraction engine 100. For example, a user may select and/or upload a document through a GUI 108 on the client computing device 109. The document 106 may be a form with parameter fields. The document 106 may be from a document management system, a network location, a local location, and/or the like. The extraction engine 100, upon receiving the document 106, may generate a signature for the document in the same manner that signatures were generated for the forms in the form database 104. For example, the extraction engine 100 may parse the document 106 to identify parameter fields and generate a signature based on those parameter fields (e.g., a list or other data structure of parameter fields). The extraction engine 100 may then compare the signature from the document 106 to each of the signatures in the form database 104 to determine if there is a matching form (e.g., if the signatures match exactly or within a predetermined tolerance).

In non-limiting embodiments, if there is a matching form (e.g., if a signature of the document matches a signature for a form in the form database 104), the instructions associated with that form may be identified and retrieved from the form database 104. In some non-limiting embodiments, a user may be prompted to approve of the instructions, edit the instructions, and/or the like through the GUI 108. If there is not a matching form, the user may be prompted through the GUI 108 to input parameter fields and/or instructions for the document 106. For example, in response to determining that a document does not match any form (e.g., a non-matching document such that the signature for the document does not match any form signature), a new form may be automatically generated and stored in the form database 104 based on a signature of that non-matching document 106. In response to a new form being generated, the user may be automatically prompted to input information about the new form, including instructions, identification of parameter fields, and/or the like. For example, a user may be asked to input and/or confirm a list of parameter fields in the document. In non-limiting embodiments, the user may be facilitated to define and/or select a category (e.g., label) for each instruction and/or parameter to be extracted, and such category may be used to group the output from the model 102 (e.g., values with the same category may be shown in the same column and/or the like). For example, one or more parameter fields may be identified as a personal identification category (e.g., names, personal addresses, and/or the like), one or more parameter fields may be identified as a location category (e.g., a country, state, and/or address of an entity or event), one or more parameter fields may be identified as a content category (e.g., a diagnoses, statute, case name, observation, description, and/or the like), and/or other like categories.

Still referring to FIG. 1, in some non-limiting embodiments, the system 1000 includes a model 102, which may further include one or more models executable by one or more computing devices and/or software applications executed by one or more computing devices. In some non-limiting embodiments, the model 102 may be stored and/or executed by the client computing device 109. Additionally or alternatively, the model 102 may be stored and/or executed by one or more servers in communication with the client computing device 109. In some non-limiting embodiments, the model 102, extraction engine 100, and/or word processing application may be integrated into one application interface. In some non-limiting embodiments, the model 102 may be remote from the client computing device 109 and accessed through a network-based service (e.g., via one or more application programming interfaces (APIs) or the like). In some non-limiting embodiments, the model 102 may be a large language model (LLM). It will be appreciated that other arrangements and types of models may be used in non-limiting embodiments.

In some non-limiting embodiments, after identifying instructions associated with the document 106, the extraction engine 100 may generate an input 110 for the model 102. The input 110 may include, for example, the document, the instructions, and/or the document parameters. In some non-limiting embodiments, the input may include the document 106 and a prompt based on or including the instructions, such that the model 102 processes the document 106 based on the instructions. For example, the instructions may prompt the model to extract values from specific document parameters and to return them in a structured format. A model output 112 may be received by the extraction engine 100 and presented on the GUI 108. The input 110 and output 112 may be communicated to and from the model 102 via an API and/or service. In non-limiting embodiments, the model output 112 may be a plurality of values of parameter fields structured (e.g., in a table, list, and/or the like), a summary of the values of parameter fields, and/or the like. The instructions may include instructions for the model 102 to transform the extracted data, including generating summaries, tables, structured data, and/or the like. In some non-limiting embodiments, the output may be normalized, filtered, cleaned, and/or processed with other operations.

In some non-limiting embodiments, the extraction engine 100 and/or model 102 may be at least partially integrated with a word processing system, which may include a word processing application such as Microsoft® Word, Google® Documents, or the like. For example, non-limiting embodiments may be provided as an add-in (e.g., a plug-in, a module, a toolbar, and/or the like) for a word processing application that can be accessed from within the existing word processing application (e.g., through a menu, toolbar, sidebar, popup window, and/or the like). In some examples, the plug-in for the word processing application may interface with a server-side application (e.g., via an API or the like).

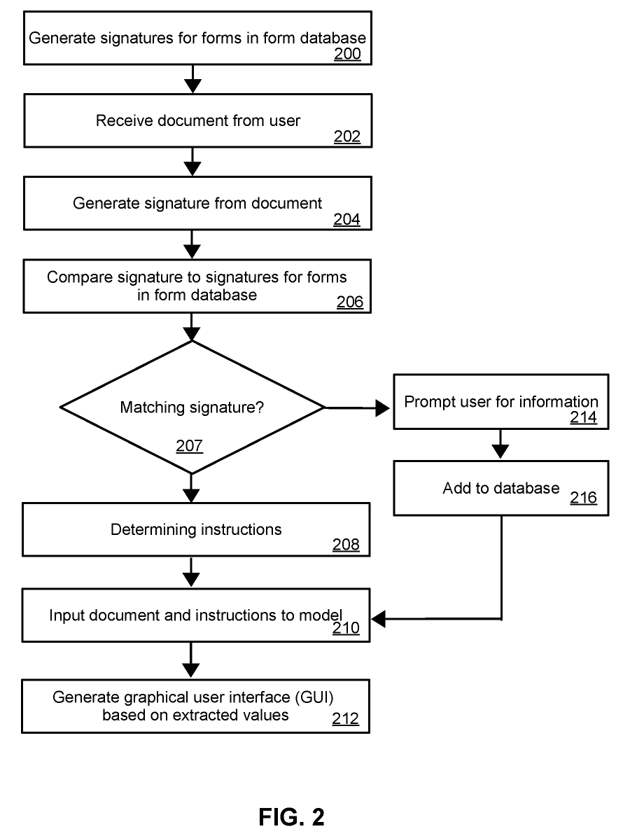

Referring now to FIG. 2, a flow chart is shown for extracting parameters from documents according to non-limiting embodiments. The steps shown in FIG. 2 are for example purposes only. It will be appreciated that non-limiting embodiments may involve additional steps, fewer steps, different steps, and/or a different order of steps. In some non-limiting embodiments or aspects, a step may be performed automatically in response to the completion of a previous step (e.g., may be performed without user intervention upon the completion of a previous step). In non-limiting embodiments, the steps shown in FIG. 2 may be executed by a computing device, such as the extraction engine 100 and/or computing device 109 shown in FIG. 1.

At step 200, signatures may be generated for each form of a plurality of forms in a database. The signature for each form may be based on one or more parameter fields in the form. The signature may include, for example, a list or other data structure of parameter fields (e.g., a type, classification, category, etc., of the parameter fields). In some non-limiting embodiments, the signature may be a processed output of a list of parameter fields, such as a hash of the parameter fields, a concatenated string of the parameter fields, an encoded or encrypted value, and/or the like. It will be appreciated that a form signature may be any unique identifier based on the parameter fields of the form, and may be encoded or not encoded.

At step 202, a document is received. For example, a user may select, identify, and/or upload a document through a GUI on a client computing device. The document may be a form with parameter fields and parameter values in one or more of the parameter fields. The document may be from a document management system, a network location, a local location, and/or the like. At step 204, a signature is generated for the document received at step 202. The signature may be automatically generated as described above in connection with step 200 in response to being uploaded. At step 206, the signature generated at step 204 is compared to the signatures generated at step 200. The comparison may be based on a matching algorithm, such as a fuzzy or exact matching algorithm, configured to determine if the signatures match exactly or within a predetermined tolerance.

In some non-limiting embodiments, a form or document may have multiple different signatures throughout the document and over multiple pages. In some examples, a signature of each individual page of the input document is generated and separately compared to the signatures in the form database. In this way, if a document has multiple signatures that would correspond to multiple forms in the database, and thereby multiple sets of instructions, all of those instructions could be determined and retrieved for processing the input document. In non-limiting embodiments, the matching may be performed on a per-page basis, per section of the document basis (e.g., if the document has delineated sections), and/or may be performed on the entirety of the document such that one document signature is matched to multiple signatures from the form database for a one-to-many match.

At step 207, it is determined whether there is a matching signature based on the comparison at step 206. If there is a matching signature, the method may proceed to step 208 and one or more instructions may be determined for the signature and/or corresponding form. For example, each signature and/or corresponding form in the form database may be associated with one or more instructions. These instructions may be retrieved at step 208 and stored in temporary memory, as an example. The instructions may include instructions for extracting and/or processing data from a document that matches a particular form. In some non-limiting embodiments, a user may be prompted to approve of the instructions, edit the instructions, and/or the like through a GUI. In such non-limiting embodiments, steps 204-208 may be performed repeatedly until all of the signatures are generated for the document and compared to the signatures for the forms in the database and corresponding instructions are determined.

At step 210, the one or more instructions and the document received at step 202 are input into one or more models such as, but not limited to, an LLM. For example, the instructions may be input to a model as a prompt along with the document itself and/or text extracted from the document. A prompt for the model may also be derived from the instructions by combining the instructions from multiple forms, formatting the instructions based on one or more rules, and/or the like. Multiple instructions may be assembled into one or more prompts. In some non-limiting embodiments, separate prompts may be generated for each instruction. In some non-limiting embodiments, separate prompts or other inputs may be separately input to different models in parallel. At step 212, a GUI is generated and/or updated based on the values extracted from the document. For example, a timeline may be generated based on the values. The values may be presented in a summary or narrative form, may be used to populate a new form or document, and/or the like.

In some non-limiting embodiments, the values may be used to modify a timeline or other like interface representing a plurality of events. For example, a timeline may be implemented as described in International Patent Application Publication No. WO 2023/069395 and U.S. Patent Application Publication No. 2024/0265193, titled “System, Method, and Computer Program Product for Identifying Events and Representing a Plurality of Events in an Interactive Graphical User Interface,” the entireties of which are incorporated herein by reference. In some non-limiting embodiments, parameter field types (e.g., categories) may be used to add additional information to a timeline, such as one or more additional columns to label each event based on a parameter field. As an example, if an accident or injury is an event on a timeline, that event may include a type of accident, a severity of the injury, a time of the accident, and/or the like. In non-limiting embodiments, a user may select to extract a particular set of data from across the documents. For example, a user may add a choice of one or more columns and/or markers to the timeline specifying a type of data (e.g., parameter field), such as but not limited to a category of event, severity, entities involved, and/or the like.

At step 207, if there is no matching signature, the method may proceed to step 214. At step 214, a user may be prompted for information about the document. For example, a user may be prompted to identify the parameter fields in the document and/or provide one or more instructions to be used in connection with the document (e.g., to prompt a model to extract parameter values from the document). The user may identify the parameter fields by typing the parameter fields, identifying the parameter fields with selectable options through a GUI, highlighting the parameter fields in the document, confirming or rejecting proposed parameter fields through a GUI, and/or the like. At step 216, the document, signature based on the document from step 204, and instructions corresponding to the document may be added to the form database. In this manner, a new form and set of instructions may be used in a future iteration if a subsequent document (e.g., received at step 202 in a subsequent performance of the method shown in FIG. 2) has a matching signature.

Non-limiting embodiments of a system and method for extracting parameters from documents may be provided as a standalone application executable by a client computer and/or server computer, an add-in (e.g., such as a plug-in) for a word processing application or browser, and/or as part of any other type of application that can interact with documents and/or receive instructions from users, such as one or more agent applications that can interact with other applications and services through an operating system or the like.

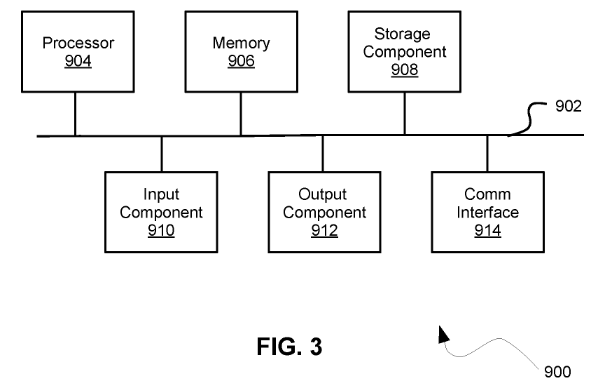

Referring now to FIG. 3, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 3. Device 900 may correspond to the client computing device 109 and/or extraction engine 100 shown in FIG. 1. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed or configured to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 3, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
a data storage device comprising a plurality of forms, each form of the plurality of forms corresponding to at least one instruction; and
at least one processor configured to:
receive at least one document from a user device;
generate at least one signature based on the at least one document;
compare the at least one signature to the plurality of forms to identify at least one matching form;
input the at least one document and the at least one instruction corresponding to the at least one matching form into a machine-learning model configured to extract values from the at least one document; and
generate at least one user interface based on the values extracted from the at least one document.

2. The system of claim 1, wherein the at least one processor is further configured to:
generate a signature for each form of the plurality of forms based on at least one parameter field in each form, wherein comparing the at least one signature to the plurality of forms comprises comparing the at least one signature to each signature for each form to identify the at least one matching form.

3. The system of claim 1, wherein inputting the at least one instruction into the machine-learning model comprises:
generating a prompt based on the at least one instruction; and
inputting the prompt and the at least one document into the machine-learning model.

4. The system of claim 1, wherein the data storage device comprises a first form repository and a second form repository, wherein the first form repository comprises the plurality of forms, wherein the plurality of forms are predetermined, and wherein the second form repository comprises a second plurality of forms uploaded by a user.

5. The system of claim 1, wherein comparing the at least one signature to the plurality of forms to identify the at least one matching form comprises separately comparing a signature of each individual page of the at least one document to the plurality of forms.

6. The system of claim 1, wherein generating the at least one signature based on the at least one document comprises determining a classification for each parameter field in the at least one document.

7. The system of claim 1, wherein generating at least one user interface based on the values extracted from the at least one document comprises at least one of the following:
generating a timeline of events based on the values,
generating a table comprising a plurality of columns, wherein each column of the plurality of columns corresponds to a classification of a value of the values extracted from the at least one document, or
any combination thereof.

8. The system of claim 1, wherein the at least one processor is further configured to:
before inputting the at least one instruction into the machine-learning model, display the at least one instruction on the user device; and
modify the at least one instruction based on user input received through the user device.

9. The system of claim 1, wherein the at least one processor is further configured to:
receive at least one second document from the user device;
generate at least one second signature based on the at least one second document;
determine that the at least one signature does not match any form of the plurality of forms;
in response to determining that the at least one signature does not match any form of the plurality of forms, prompt a user of the user device to identify parameter fields of the at least one document; and
add the at least one second document to the plurality of forms.

10. A computer-implemented method comprising:
receiving at least one document from a user device;
generating, with at least one processor, at least one signature based on the at least one document;
comparing, with at least one processor, the at least one signature to a plurality of forms to identify at least one matching form;
inputting, with at least one processor, the at least one document and at least one instruction corresponding to the at least one matching form into a machine-learning model configured to extract values from the at least one document; and
generating, with at least one processor, at least one user interface based on the values extracted from the at least one document.

11. The method of claim 10, further comprising:
generating a signature for each form of the plurality of forms based on at least one parameter field in each form, wherein comparing the at least one signature to the plurality of forms comprises comparing the at least one signature to each signature for each form to identify the at least one matching form.

12. The method of claim 10, wherein inputting the at least one instruction into the machine-learning model comprises:
generating a prompt based on the at least one instruction; and
inputting the prompt and the at least one document into the machine-learning model.

13. The method of claim 10, wherein the data storage device comprises a first form repository and a second form repository, wherein the first form repository comprises the plurality of forms, wherein the plurality of forms are predetermined, and wherein the second form repository comprises a second plurality of forms uploaded by a user.

14. The method of claim 10, wherein comparing the at least one signature to the plurality of forms to identify the at least one matching form comprises separately comparing a signature of each individual page of the at least one document to the plurality of forms.

15. The method of claim 10, wherein generating the at least one signature based on the at least one document comprises determining a classification for each parameter field in the at least one document.

16. The method of claim 10, wherein generating at least one user interface based on the values extracted from the at least one document comprises at least one of the following:
generating a timeline of events based on the values,
generating a table comprising a plurality of columns, wherein each column of the plurality of columns corresponds to a classification of a value of the values extracted from the at least one document, or
any combination thereof.

17. The method of claim 10, further comprising:
before inputting the at least one instruction into the machine-learning model, displaying the at least one instruction on the user device; and
modifying the at least one instruction based on user input received through the user device.

18. The method of claim 10, further comprising:
receiving at least one second document from the user device;
generating at least one second signature based on the at least one second document;
determining that the at least one signature does not match any form of the plurality of forms;
in response to determining that the at least one signature does not match any form of the plurality of forms, prompting a user of the user device to identify parameter fields of the at least one document; and
adding the at least one second document to the plurality of forms.

19. A computer program product comprising at least one non-transitory computer-readable medium including program instructions that, when executed by at least one processor, cause the at least one processor to:
receive at least one document from a user device;
generate at least one signature based on the at least one document;
compare the at least one signature to the plurality of forms to identify at least one matching form;
input the at least one document and at least one instruction corresponding to the at least one matching form into a machine-learning model configured to extract values from the at least one document; and
generate at least one user interface based on the values extracted from the at least one document.
